(19) United States
(12) Patent Application Publication
(10) Pub. No.: US 2016/0086220 A1
(43) Pub. Date: Mar. 24, 2016

(54) TERMINAL DEVICE AND DEVICE PROGRAM

(71) Applicant: NEC Personal Computers, Ltd., Tokyo (JP)

(72) Inventors: Takahisa Shirakawa, Tokyo (JP); Yoshiki Iwamoto, Tokyo (JP); Takeshi Iino, Tokyo (JP)

(73) Assignee: NEC Personal Computers, Ltd., Tokyo (JP)

(21) Appl. No.: 14/786,772

(22) PCT Filed: Mar. 6, 2014
(86) PCT No.: PCT/JP2014/055762

§ 371 Date: Oct. 23, 2015

(30) Foreign Application Priority Data
Apr. 25, 2013 (JP) 2013-092256

(51) Int. Cl. G06Q 30/02

(52) U.S. Cl. CPC G06Q 30/0255; G06Q 30/0269

(57) ABSTRACT

A terminal device and a device program having a high degree of convenience that are capable of selectively displaying a list of content information interesting to a user and do not need to allow an external server to acquire the degree of interest for the content information.

The terminal device acquires distribution information of a predetermined kind for content information through a network, estimates a degree of interest of a user using the terminal device for the content information based on an operation content for the content information, and selects content information that is a display target from new content information corresponding to the distribution information acquired based on at least the degree of interest for the content information of the past that is estimated.

### TECHNICAL FIELD

The present invention relates to a terminal device and a device program capable of displaying content information that is acquired through a network.

### BACKGROUND ART

Generally, a method is known to transmit information related to a registered field from a web server to a terminal device by registering the field in which a user is interested to the web server. By using such a method, among various kinds of information that can be acquired through a network, only information that is interesting to a user is displayed on the terminal device, whereby the user convenience is improved.

In addition, a system is known in which content information is distributed from an external content information distribution server that is connected to and used with an electronic commerce apparatus or an SNS server to a terminal device through a network (for example, see Patent Document 1). In such a system, when a content list acquisition request is received from the terminal device, the content information distribution server specifies a predetermined number of categories having high evaluation values for a user using the terminal device. In addition, the content information distribution server extracts overview information of contents stored in association with the specified categories from feeds acquired through web server circulation. Then, the extracted overview information of contents is generated as a content list, and the content list is transmitted to the terminal device through a network so as to be displayed thereon.

In addition, a terminal device is known which receives a bunch of advertisements altogether from a server providing advertisement information and selects an advertisement to be displayed on an advertisement display unit arranged inside a display screen of an application (for example, see Patent Document 2). In such a device, from the viewpoint of privacy, operation history information of the terminal device is not transmitted to an external server, but stored in a local operation history DB, and an advertisement to be displayed on the advertisement display unit is selected based on the operation history information.

### PRIOR ART REFERENCE

### Patent Document

Patent Document 1: JP 2010-262534 A

Patent Document 2: JP 2007-172174 A

### SUMMARY OF INVENTION

### Problems to be Solved by the Invention

However, in a configuration such as the configuration disclosed in Patent Document 1 described above in which a content list is received by a terminal device from an external server through a network, in order to receive a list of content information interesting to a user, it is necessary to allow the degree of user's interest for each content information to be acquired by the external server.

Alternatively, also in the configuration in which information is registered in an external web server as described above, the external server is allowed to acquire personal information such as the degree of user's interest for each content information and a mail address, and accordingly, there is concern of the leakage of privacy.

In addition, even in a case where the cost for a security plan for the prevention of leakage of privacy to the external server is sufficiently increased, there are cases where a large quantity of advertisement mails and the like are transmitted based on the acquired degree of interest for each content information. For this reason, there are cases where displeasure is given to users who do not want the transmission of such mails.

Furthermore, the device disclosed in Patent Document 2 described above is for selecting an advertisement to be displayed on the advertisement display unit, but it is not considered to improve the convenience by allowing the user to easily select content information that is desired to be seen.

This means that it is not considered to improve the user experience of the terminal device by displaying a list of selected content information interesting to the user among acquirable content information of various data amounts and various kinds.

The present invention is devised in consideration of such situations, and an object thereof is to provide a terminal device and a device program having a high degree of convenience that are capable of selectively displaying a list of content information interesting to a user and do not need to allow an external server to acquire the degree of interest for the content information.

### Means for Solving to the Problems

In order to achieve such an object, a terminal device according to the present invention is a terminal device that is connectable to a server device through a network. The terminal device includes: an acquisition means that acquires distribution information of a predetermined kind for content information through the network; an interest estimating means that estimates a degree of interest of a user using the terminal device for the content information based on an operation content for the content information; a selection means that selects content information that is a display target from new content information corresponding to the distribution information acquired by the acquisition means based on at least the degree of interest for the content information of the past that is estimated by the interest estimating means; a list information generating means that generates list information used for displaying, as a list, the content information selected by the selection means as the display target by using the distribution information acquired by the acquisition means for each selected content information; and a display screen generating means that generates a list display screen on which the list information of a predetermined number generated by the list information generating means is arranged, and the interest estimating means updates the degree of interest when a predetermined operation input is made for the content information.

In addition, a terminal device program according to the present invention is a program of a terminal device that is connectable to a server device through a network. The program causes the terminal device to execute: acquiring distribution information of a predetermined kind for content information through the network; estimating a degree of interest of a user using the terminal device for the content information based on an operation content for the content information; selecting content information that is a display target from new content information corresponding to the distribution information acquired in the acquiring of the distribution information based on at least the degree of interest for the content information of the past that is estimated in the estimating of the degree of interest; generating list information used for displaying, as a list, the content information selected in the selecting of the content information as the display target by using the distribution information acquired for each selected content information in the acquiring of the distribution information; and generating a list display screen on which the list information of a predetermined number generated in the generating of the list information is arranged, and the degree of interest is updated by the estimating of the degree of interest when a predetermined operation input is made for the content information.

### Advantageous Effects of the Invention

As above, according to the present invention, the degree of interest for content information does not need to be acquired by an external server, and a list of selected content information interesting to the user can be displayed. For this reason, a terminal device and a device program having a high degree of convenience can be provided.

### BRIEF DESCRIPTION OF THE DRAWINGS

FIG. 1 is a block diagram that illustrates an example of the configuration of the periphery of a terminal device 100 as a first embodiment of the present invention.

FIG. 2 is a flowchart that illustrates an example of the operation of the terminal device 100 according to the first embodiment.

FIG. 3 is a diagram that illustrates an example of transitions among display screens according to the terminal device 100.

FIG. 4 is a diagram that illustrates a specific example of a selection screen 501 of an application.

FIG. 5 is a diagram that illustrates a specific example of a list display screen of time order 502.

FIG. 6 is a diagram that illustrates a specific example of a list display screen of category order 503. FIG. 7 is a diagram that illustrates a specific example of a detailed display screen 506.

FIG. 8 is a diagram that illustrates a specific example of an interest setting screen 507.

FIG. 9 is a block diagram that illustrates an example of the configuration of the periphery of a terminal device 100 as a second embodiment.

FIG. 10 is a flowchart that illustrates an example of the operation executed by the terminal device 100 according to the second embodiment.

FIG. 11 is a block diagram that illustrates an example of the configuration of the periphery of a terminal device 100 as a third embodiment.

FIG. 12 is a diagram for describing the concept of accumulated points accumulated for each category and for each time period in the third embodiment.

FIG. 13 is a flowchart that illustrates an example of the operation according to a fourth embodiment.

### DESCRIPTION OF THE EMBODIMENTS

Next, terminal devices and device programs according to embodiments of the present invention will be described in detail with reference to the drawings.

A terminal device according to the present invention may be any device such as a PC or a smartphone.

### First Embodiment

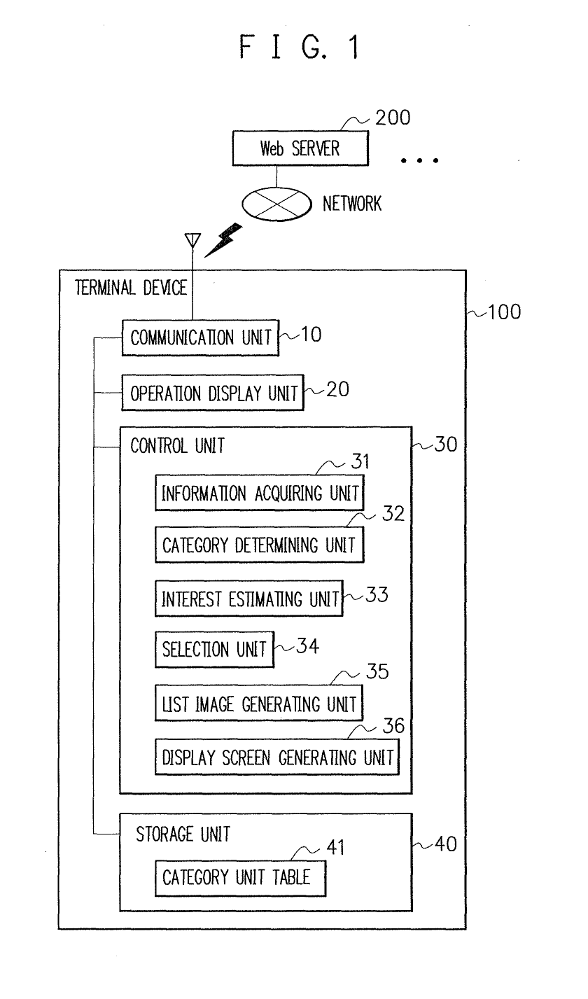

First, a first embodiment of the present invention will be described. FIG. 1 illustrates an example of the configuration of the periphery of a terminal device 100 according to the first embodiment. The terminal device 100 according to this embodiment, as illustrated in FIG. 1, is configured to include: a communication unit 10; an operation display unit 20; a control unit 30; and a storage unit 40.

The communication unit 10 is connected to various web servers and the like through a network such as the Internet in a wired or wireless manner. In addition, the communication unit 10 includes a TV reception antenna and a TV tuner and receives a TV program table and a TV program broadcast.

The operation display unit 20 is, for example, a touch panel display or the like, and displays various kinds of information on the screen and receives a user's operation input.

The control unit 30 controls the terminal device 100 and is configured to include: an information acquiring unit 31; a category determining unit 32; an interest estimating unit 33; a selection unit 34; a list image generating unit 35; and a display screen generating unit 36.

The information acquiring unit 31 is connected to various web servers 200 through a network by the communication unit 10 and acquires distribution information of a predetermined kind according to settings. The distribution information of a predetermined kind acquired by the information acquiring unit 31 is information stored at various web servers 200 for the distribution such as various feeds, which represents the content of content information that can be a reproduced by the terminal device 100.

For example, the information acquiring unit 31 may acquire as a feed an RDF site summary (RSS) feed, an extensible markup language (XML), Atom, or a resource description framework (RDF), which may include various kinds of information that can be analyzed by an aggregator. In addition, the feed does not need to be recognized in a file format by an operating system (OS) but, for example, may include data of a binary format.

In addition, in a case where various social networking service (SNS) are set as content information that is a reproduction target, the control unit 30, for example, may be realized by using an application programming interface (API). In such a case, the information acquiring unit 31 acquires from the API various kinds of update information such as an activity and a posted article for a person set in advance.

In addition, in a case where the communication unit 10 is configured to include a TV reception antenna and a TV tuner, the information acquiring unit 31 receives a TV program table. In this way, the information acquiring unit 31 acquires various kinds of information relating to a viewable TV program as distribution information of a predetermined kind representing the content of content information for reproduction.

Furthermore, in a case where the content information for reproduction is information which doesn't have corresponding distribution information of a certain summarized format, such as a web leaflet of a region, the information acquiring unit 31 acquires the content information itself for reproduction from the web server 200 or the like.

As above, the content information for reproduction of the terminal device 100 according to this embodiment may include content information of an arbitrary kind that can be reproduced according to the configuration of the terminal device 100.

The category determining unit 32 determines a category unit set in advance into which content information for reproduction is classified according to distribution information of a predetermined kind acquired by the information acquiring unit 31.

Here, category units are classification units into which various kinds of content information, which can be reproduced, are classified according to the content thereof and may include, for example, soccer news, weather forecasts, leaflet information of a predetermined area, a predetermined SNS, and the like.

In addition, a category unit table 41 representing a list of categories set in advance is stored in the storage unit 40. The list of category units included in the category unit table 41 may be configured to be set as an initial setting or be configured to be registered according to a user setting.

The category determining unit 32 determines a category unit in which content information that is a reproduction target is included, for example, based on distribution source information of the feed acquired by the information acquiring unit 31.

In addition, the category determining unit 32 may determine the category unit by analyzing the content of the distribution information of a predetermined kind acquired by the information acquiring unit 31. In such a case, any one of various methods can be used to determine the category unit such as whether or not a predetermined keyword is included in text data included in the acquired distribution information of a predetermined kind.

The interest estimating unit 33 estimates the degree of interest of the user using the terminal device 100 for content information in accordance with an operation for the content information for reproduction. In the estimation of the degree of interest by the interest estimating unit 33, in a case where a predetermined operation is executed as an operation relating to the reproduction and recording of content information, points determined in advance in accordance with the operation are assigned to the content information as an operation target.

For example, in a case where a reproduction operation of content information is executed using a web browser or the like, one (1) point is assigned to the content information as a reproduction target. In addition, in a case where a storage operation for storing into the storage unit 40 is executed, three (3) points are assigned to content information as a storage target. Furthermore, in a case where a post is made for a reproduced content by using a “like” button or the like, five (5) points are assigned to the content information. In addition, in a case where a removal operation of removing a content is executed for a content, −15 points are assigned to the content information as a removal target.

In addition, in a case where a content for reproduction is a web site, predetermined points may be assigned by using a time during which the web site is continued to be displayed as a staying time. By assigning points as such, weighting for each content is executed in accordance with an operation content.

Then, the interest estimating unit 33 calculates accumulated points acquired by adding up points for each category unit in which the content information, to which the points are assigned, is included. In this way, the interest estimating unit 33 compares the accumulated points of the category units, thereby determining the order of category units according to user's interest.

The selection unit 34 selects content information as a display target for a list screen to be displayed on the operation display unit 20 from among a new content information group corresponding to the distribution information of the predetermined kind acquired by the information acquiring unit 31. The display format of the list screen may be variously set in accordance with the setting. The selection unit 34, in accordance with the set display format, selects a predetermined number of content information as a display target for the list screen by using the degree of interest for the content information of the past estimated by the interest estimating unit 33 or the like.

The display target described in this specification may include, in addition to a display content displayed at one time on the operation display unit 20, a display content aligned in a portion displayed by scrolling the screen.

The list image generating unit 35 generates a list image (list information) used for displaying a list of content information matching the user's interest as a list screen. The list image is generated in correspondence with each content information as a display target and is configured by text data, an image, and the like. In this way, the list image provides a beautiful appearance and serves also as a link source for displaying a web site of a link destination by a web browser.

The list image generating unit 35 generates a list image corresponding to the content information as a display target by using the distribution information of a predetermined kind that is acquired by the information acquiring unit 31.

In addition, in order to generate the list image, the list image generating unit 35 acquires other information of a predetermined kind as additional information if such information is additionally required as detailed information or image information. The additional information may be determined in advance in accordance with the kind of the content information as a display target, for example, as in a case where, for a category unit of “soccer news”, representative image data is acquired from a target web server or the like. In addition, in a case where a list image can be generated using the distribution information of a predetermined kind acquired by the information acquiring unit 31, the list image may be generated without using additional information.

As above, the list image generating unit 35 generates a list image corresponding to each content information selected as a display target using the distribution information of a predetermined kind acquired by the information acquiring unit 31, by using, for example, a method of arranging image data and summary text data included in the RSS feed in a layout determined in advance or the like.

The display screen generating unit 36 arranges the list image generated by the list image generating unit 35 within a predetermined screen format in accordance with the set display format of the list screen, thereby generating a list display screen to be displayed on the operation display unit 20. The list image is sequentially arranged from a category unit having higher accumulated points based on the degree of interest estimated by the interest estimating unit 33 and is arranged within a predetermined screen format of the list display screen in accordance with the set display format.

The display screen described in this specification may include, in addition to a display content displayed at one time on the operation display unit 20, a display content aligned in a portion displayed by scrolling the screen.

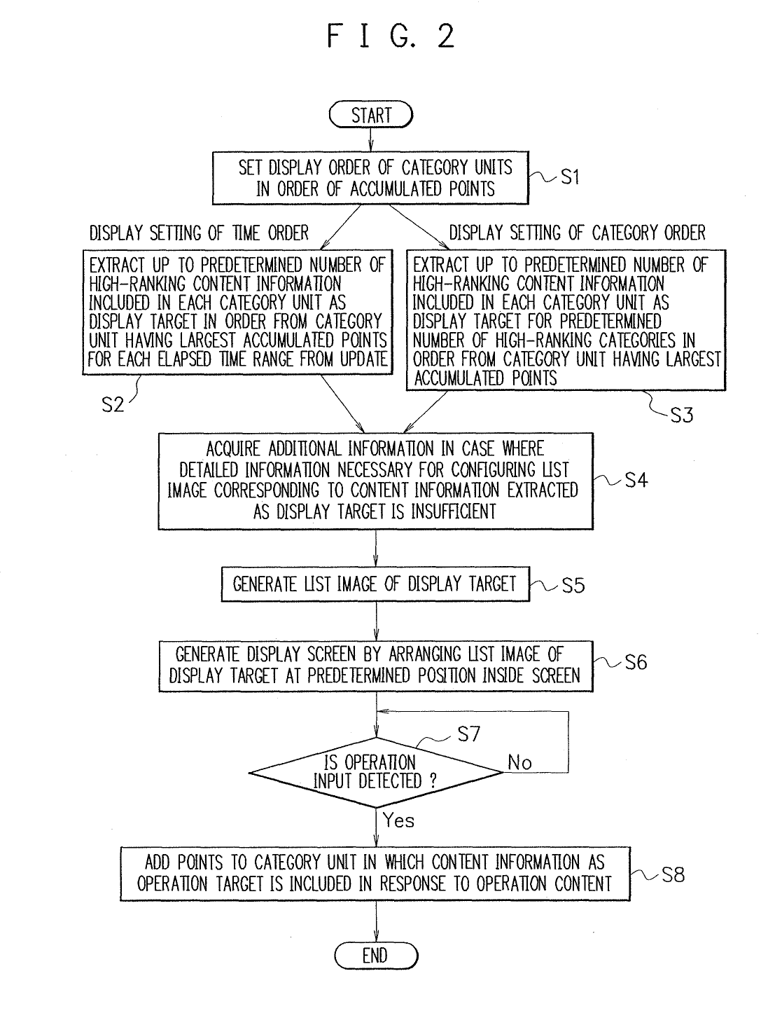

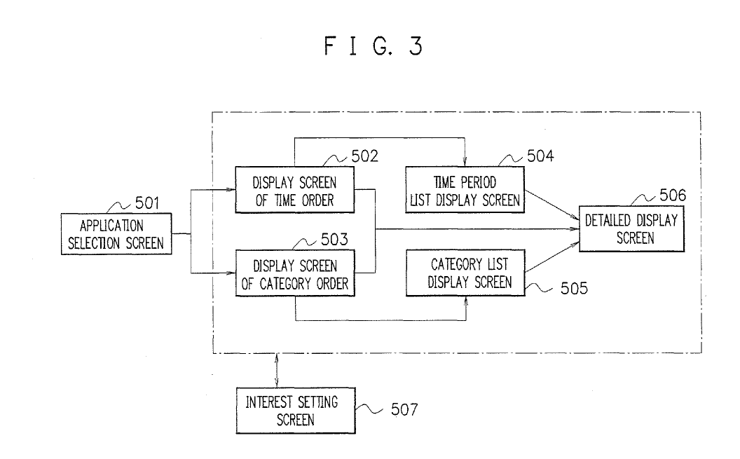

Next, an example of the operation executed by the terminal device 100 according to this embodiment will be described with reference to a flowchart illustrated in FIG. 2 and examples of screen transitions illustrated in FIGS. 3 to 8.

In the terminal device 100 according to this embodiment, the interest estimating unit 33 estimates the degree of interest as described above in accordance with a user's operation for the display screen displayed on the operation display unit 20.

An example of transitions among display screens used for the user executing various operations using the terminal device 100 according to this embodiment is illustrated in FIG. 3.

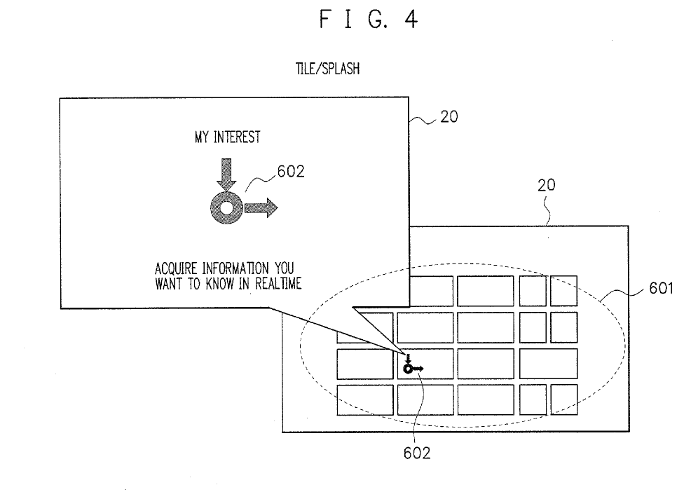

On the operation display unit 20 of the terminal device 100, first, a selection screen 501 of an application configured by an OS is displayed. On this selection screen 501 of an application, for example, as illustrated in FIG. 4, an icon group 601 representing applications that are launchable is displayed. Among this icon group 601, an icon of an application that provides the list display screen according to this embodiment is assumed to be included. FIG. 4 illustrates the icon as an icon including a logo mark 602 of the application.

On the selection screen 501 of an application, when an icon of an application that provides a function according to this embodiment is clicked, a list display screen of content information configured in order of the time or in order of the category is displayed in accordance with the setting, as illustrated in FIG. 3.

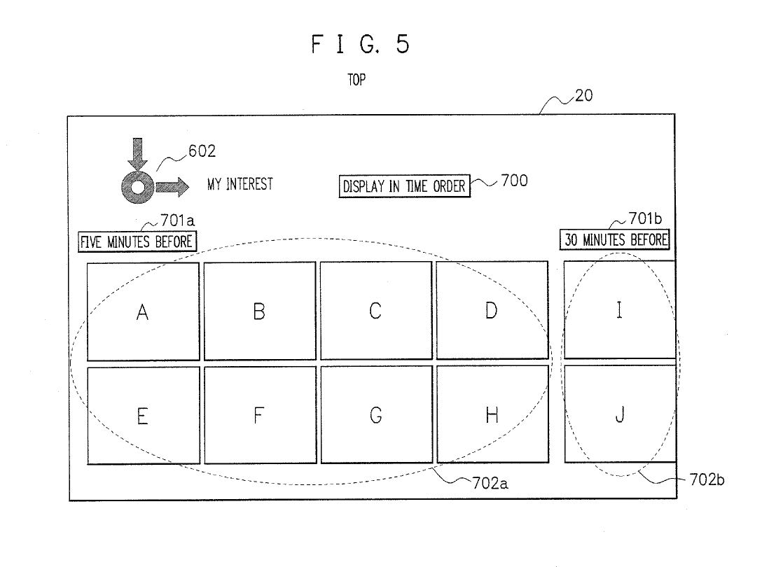

On a list display screen of time order 502, for example, as illustrated in FIG. 5, “Display in Order of Time” is displayed as a display mode setting 700, and, for each display unit 701 that represents an elapsed time range from the update, a list image group 702 of a predetermined number is displayed. In the example illustrated in FIG. 5, as the display units 701, the list image groups are arranged in order of “five minutes before” representing a range within five minutes from the update and “30 minutes before” representing a range after five minutes from the update and within 30 minutes from the update. In addition, for each display unit 701 that is an elapsed time range, eight list images are arranged as the list image group 702, whereby the list display screen of time order 502 is configured.

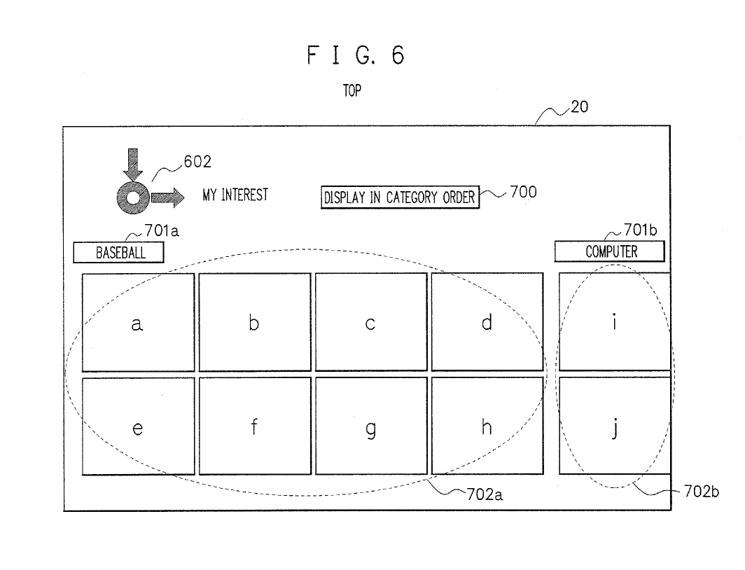

On a list display screen of category order 503, for example, as illustrated in FIG. 6, “Display in Order of Category” is displayed as the display mode setting 700, and, for each display unit 701 that represents a display category that is a display target, a list image group 702 of a predetermined number is displayed. In the example illustrated in FIG. 6, as the display units 701, “Baseball” and “Computer” are arranged in order of the degree of user's interest in the categories. In addition, for each display category that is a display unit 701, eight list images are arranged as the list image group 702, whereby the list display screen of category order 503 is configured.

In addition, the display category as a display unit 701 may be the same as the category unit determined by the category determining unit 32 or may be acquired by compiling a plurality of category units. For example, a display category of “Domestic News” may be configured by compiling predetermined category units of “Soccer News”, “Political News”, and the like.

Furthermore, when a display unit 701 representing an elapsed time range from the update is clicked on the list display screen of time order 502, as illustrated in FIG. 3, a time period list display screen 504 on which list images corresponding to content information updated in the elapsed time range of the display unit 701 are arranged is displayed.

In addition, when a display unit 701 representing a display category is clicked on the list display screen of category order 503, as illustrated in FIG. 3, a category list display screen 505 on which list images corresponding to content information classified into the display category of the display unit 701 are arranged is displayed.

Furthermore, any one list image of the list image group 702 displayed on each of the list display screen of time order 502, the list display screen of category order 503, the time period list display screen 504, and the category list display screen 505 as described above is clicked, as illustrated in FIG. 3, a detailed display screen 506 of content information corresponding to the clicked list image is displayed.

On the detailed display screen 506, in a case where the content information corresponding to the clicked list image is, for example, a news article, as illustrated in FIG. 7, a title 800 of the article, a representative image 801, the other image group 802, and an article text 803 are displayed. In the example illustrated in FIG. 7, when any one image displayed as the other image group 802 is clicked, the image is displayed in an enlarged scale as the representative image 801.

In this way, the detail of the content information is displayed using the detailed display screen 506, and the displayed content information is recorded in the storage unit 40 arranged inside the terminal device 100 by an operation unit not illustrated in the figure or the like.

In addition, in accordance with the kind of content information corresponding to the clicked list image, the detailed display screen 506 reproduces the content information of the kind, whereby the content is reproduced by an application or a plugin determined in advance. Furthermore, in accordance with a user's operation from an operation unit not illustrated in the figure or the like, not only the reproduction of the content, but also various operations such as posting, recording or removing the content can be executed.

For example, in a case where the kind of the content information is a TV program, on the detailed display screen 506, the TV program can be viewed, and various operations such as a recording operation and a timer recording setting operation of a TV program can be executed.

Meanwhile, for example, in a case where the kind of the content information is various SNS's, on this detailed display screen 506, posted articles in the SNS for a selected person are displayed in a reverse chronological order of posting time, and various operations such as commenting on each posted article and recording an image in a device can be executed.

In addition, by invoking a setting screen from any one of the list display screen of time order 502, the list display screen of category order 503, the time period list display screen 504, the category list display screen 505, and the detailed display screen 506 as described above, as illustrated in FIG. 3, an interest setting screen 507 is displayed.

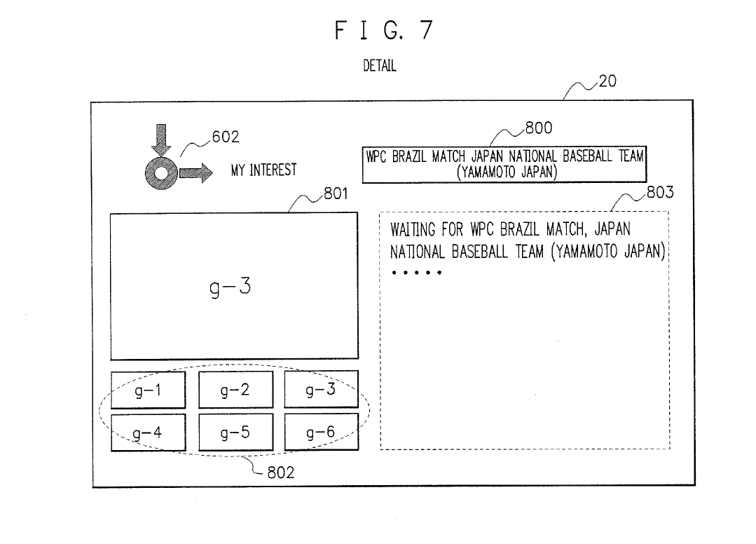

On the interest setting screen 507, for example, as illustrated in FIG. 8, a display category group 902 is displayed in association with each large classification 901 that is acquired by compiling category units in a large scale. In the display category group 902, display categories classified into same large classification 901 are compiled and displayed. In addition, the display categories are distinguished by different colors and displayed in order of highest to lowest interest based on each total sum of degrees of interest for the content information estimated by the interest estimating unit 33. FIG. 8 illustrates an example of a case where the display categories are classified into several levels with color classification of ten levels from “viewing frequently” to “viewing rarely” for display.

Based on such an interest setting screen 507, the user can check the degree of interest for the content information estimated by the interest estimating unit 33 for each display category. In addition, only content information that is classified into a specific display category may be configured not to be displayed in the list image group 702 on each list display screen described above by using a setting button not illustrated in the figure or the like.

According to the screen transition as described above, when the user makes a predetermined operation input relating to reproduction and recording of various kinds of content information, the interest estimating unit 33 assigns points to the content information as an operation target as described above and estimates the degree of interest for each category unit.

The operation of generating the list display screen based on the estimation of the degree of interest will be described with reference to a flowchart illustrated in FIG. 2.

The selection unit 34 sets display order that starts from a category unit having a largest accumulated points as a category unit in which the user is interested much based on the accumulated points for each category unit that are calculated by the interest estimating unit 33 (Step S1).

When the power is applied to the terminal device 100 for the first time, the point accumulation according to a user operation are not performed yet, and thus, there is no accumulated point. Thus, the display order of category units is set based on points set in advance as default for each category unit. The points or the display order of category units set as default may be arbitrary in accordance with the setting or the like.

Here, the selection unit 34 checks whether the initial list display screen displayed by clicking, on the application selection screen 501 described above, an icon of an application providing the function of this embodiment is set as the list display screen of time order 502 or the list display screen of category order 503.

In a case where the list display screen of time order 502 is set as the initial list display screen, the selection unit 34, for each elapsed time range from the update which is used as the display unit 701 described above, extracts up to a predetermined number of content information, which is included in each category unit, so as to set the content information included in the category unit as a display target in order from a category unit having largest accumulated points (Step S2).

For each display unit 701, the number of list images included in the list image group 702 as display targets are set in advance according to the display format as described above. For this reason, the selection unit 34 extracts certain number of content information to be displayed corresponding to the number of the list images for each display unit 701 through the extraction process of Step S2.

For this reason, for information of which the elapsed time range from the update is within a predetermined range among the distribution information of a predetermined kind acquired by the information acquiring unit 31, in order from content information included in a category unit having largest accumulated points, content information included in the category unit is extracted as a display target.

The number of content information to be extracted for each category unit may be determined appropriately in accordance with the setting or the like. Alternatively, the number of content information to be extracted for each category unit may be calculated using a predetermined method according to the accumulated points for each category unit. Furthermore, for each category unit, the display order of list images of each content information included in the category unit may be determined by using any one of various methods and, for example, may be calculated by using a predetermined method.

In a case where the list display screen of category order 503 is set as the initial screen, the selection unit 34, for a predetermined number of high-ranking display categories, extracts content information included in the category units classified in the display categories as display targets up to a predetermined number in order from a display category having largest accumulated points (Step S3).

The number of list images included in the list image group 702 as display targets is set for each display unit 701 in advance according to the display format as described above. Accordingly, the selection unit 34 extracts the number of content information as a display target for each display unit 701 that corresponds to the number of the list images in the extraction process of Step S3.

For this reason, for each one of a predetermined number of display categories having larger accumulated points among the distribution information of a predetermined kind acquired by the information acquiring unit 31, in order from a category unit having largest accumulated points, content information included in the category unit is extracted as a display target.

The number of content information to be extracted for each category unit may be determined appropriately in accordance with the setting or the like. Alternatively, the number of content information to be extracted for each category unit may be calculated using a predetermined method according to the accumulated points for each category unit. Furthermore, for each category unit, the display order of list images of each content information included in the category unit may be determined by using any one of various methods and, for example, may be calculated by using a predetermined method.

In this way, when the content information is extracted as the display target by the selection unit 34, the list image generating unit 35 generates list images corresponding to the content information extracted as the display target. Information necessary for generating the list images is set in advance according to the content information. For example, a representative image, an abstract within a predetermined length range, and the like may be set as the information necessary for generating the list images.

For this reason, the list image generating unit 35 checks whether the distribution information of the predetermined kind acquired by the information acquiring unit 31 is sufficient or insufficient for generating list images for each content information extracted as the display target. In a case where the information is insufficient, the list image generating unit 35 acquires the missing detailed information, for example, data of a representative image or the like from a web server of the distribution source or the like as the additional information (Step S4).

If the information for each content information as a display target is sufficient for generating list images, the list image generating unit 35 generates list images for each content information by using the information (Step S5).

The display screen generating unit 36 arranges the list images generated by the list image generating unit 35 at predetermined positions on the list display screen of the set display format, thereby generating a list display screen (Step S6). In this way, the list display screen is displayed on the operation display unit 20.

The interest estimating unit 33 monitors predetermined operations such as a reproduction request, a removal request, no operation (an operation for only the other contents), storage, information transmission for another service, a search, and the like for each content of the list image displayed by the display unit (Step S7).

When an operation is detected, the interest estimating unit 33 assigns points to each content information as the operation target as described above. Then, the interest estimating unit 33 estimates a total sum of the degrees of interest for each category unit by adding up the assigned points for each category unit as described above (Step S8).

In addition, also after a series of the operations of Steps S1 to S8 described above, the interest estimating unit 33 continues to monitor a predetermined operation input relating to the reproduction and recording of various kinds of content information in Step S7. Then, with each predetermined operation input, the interest estimating unit 33 updates the accumulated points for each category unit in accordance with the content of the operation.

In this way, content information extracted as the display target by the selection unit 34 changes for each extraction, and, as a result, list images configuring the list display screen changes. For this reason, as the user continues to execute various operations such as a reproduction operation and a recording operation on the list display screen, the user's interest is further reflected on the list images configuring the list display screen.

As above, the terminal device 100 according to this embodiment described above acquires the distribution information of a predetermined kind for content information of each category unit from various web servers 200 and stores the acquired information inside the terminal device 100. In addition, the terminal device 100 estimates the degree of interest according to the content of a user's operation by using the interest estimating unit 33. In this way, the terminal device 100 selects the content information as a display target from the distribution information of the predetermined kind for the content information of each category unit stored inside the terminal device 100 in order of the degree of user's interest and generates a list display screen using the list images.

Here, the terminal device 100 selects the content information as a display target by the selection unit 34 according to the accumulated points that are a total sum of points added up for each category unit. This means that the selection is made using also the points counted for the other content information classified into a category unit into which the content information as a selection target is classified. For this reason, the content information as a display target can be selected based on the degree of interest estimated based on contents of various operations.

Then, when a list image arranged on the list display screen is clicked, the terminal device 100 reproduces the content information by, for example, a predetermined application or plugin such as a web browser.

For this reason, without disclosing the degree of user's interest in each content information or registering personal information such as a mail address to an external server or the like, the terminal device 100 can display a list of selected content information including only the information interesting to the user.

For this reason, the terminal device 100 can be securely configured from the viewpoint of privacy protection without concern that unnecessary advertisement mails and the like may be massively transmitted because of the improper acquisition of the degree of user's interest in each content information in an external server.

In addition, there is no concern that various kinds of personal information leak to the outside, and the personal information can be reliably protected.

In addition, the terminal device 100 can display list images of the content information in order of highest to lowest degree of user's interest and a list display screen excluding the content information of a category unit for which the degree of interest is less than a predetermined rank from the display target.

Because the terminal device 100 can automatically and selectively display a list of interesting content information for the user, the terminal device 100 can be a favorite device that the user desires to use more frequently.

In addition, the terminal device 100 can provide a comfortable operational feeling which invites the user for the daily use by beautifully configured list display screen and by the usability that the user can reproduce the content information by only clicking the list image on the list display screen.

Furthermore, without the user's particular setting operation, the interest estimating unit 33 updates the degree of interest each time of use by only executing a desired operation, for example, reproducing a content desired to be viewed by the user. In addition, when a predetermined operation input is made, the interest estimating unit 33 updates the result of the estimation of the degree of interest.

For this reason, the result of the estimation of the degree of interest is sequentially fed back to the generation of the list display screen of the next and subsequent times, and the user's interest is further reflected on information selected by the selection unit 34. In this way, the more often the user uses, the more accurately the user's interest can be reflected, and the terminal device 100 can be the device that the user wants to use on a daily basis.

### Second Embodiment

Next, a second embodiment of the present invention will be described. In the second embodiment, the interest estimating unit 33 according to the first embodiment described above further includes a similarity determining unit 37, and the estimation of the degree of interest is configured to be made by further using the similarity acquired by the similarity determining unit 37. Parts corresponding to those of the first embodiment described above will not be presented here.

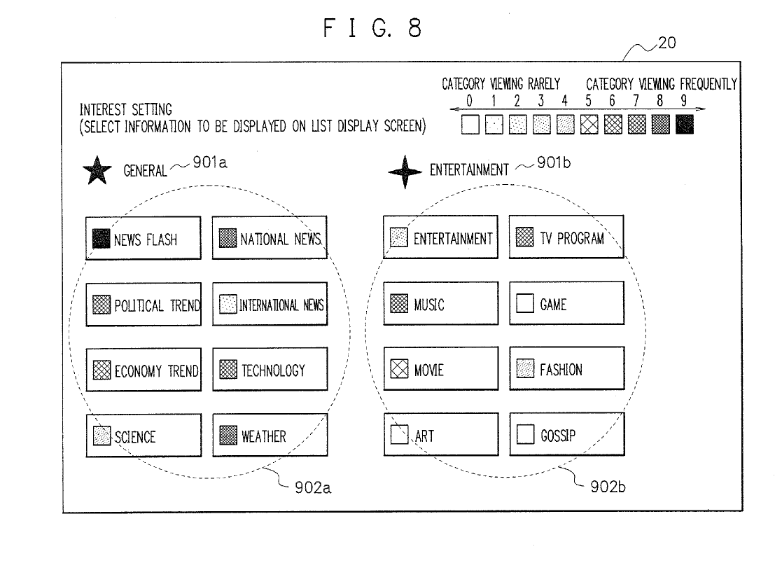

FIG. 9 illustrates an example of the configuration of the periphery of a terminal device 100 according to the second embodiment. In the terminal device 100 according to the second embodiment, in addition to the configuration of the first embodiment described above, the interest estimating unit 33 includes the similarity determining unit 37. In addition, the interest estimating unit 33 stores keyword history information 42 in a storage unit 40.

The keyword history information 42 is configured by associating a keyword group extracted from the distribution information of the predetermined kind acquired by the information acquiring unit 31 according to a predetermined algorithm as keywords representing the contents thereof with points representing the degree of interest in content information corresponding to distribution information of a predetermined kind. The keyword history information 42 may also be configured by associating distribution information of a predetermined kind acquired by the information acquiring unit 31 with points representing the degree of interest.

The similarity determining unit 37 determines a similarity between the keyword history information 42 stored in the storage unit 40 and the distribution information of the predetermined kind acquired by the information acquiring unit 31. Any one of various methods including a method in which text data is extracted from each of the keyword history information and the distribution information, and related phrases are compared with each other and the like may be used as a method of determining the similarity.

When a predetermined operation input is made for a list image displayed as the list display screen, the interest estimating unit 33 assigns points set in advance in accordance with a content of the operation input to content information corresponding to the list image. In addition, the interest estimating unit 33 extracts keywords and the like characterizing the content of the content information from the distribution information of the predetermined kind acquired by the information acquiring unit 31 for the content information corresponding to the list image, associates with points assigned to the extracted keyword group to configure the keyword history information 42 described above, and stores the keyword history information 42 in the storage unit 40.

The keyword history information 42 for each predetermined operation input until the time of this process is stored in the storage unit 40 and is accumulated as a history of content information as a target for the operation input.

The similarity determining unit 37 determines a similarity between the keyword history information 42 for each content information stored in the storage unit 40 before the operation input and the distribution information of the predetermined kind acquired by the information acquiring unit 31 as described above. Accordingly, similarities are determined as many as the number of the keyword history information 42 for each content information stored in the storage unit 40 before the operation input.

The interest estimating unit 33 weights the similarity with the keyword history information 42 for each content information calculated in this way by using the points associated with the keyword history information 42 and calculates an evaluation value by adding up the weighted similarities. For example, a method to accumulate products of similarities calculated for the keyword history information 42 for each content information and the points may be used as a weighting method.

In addition, when the keyword history information 42 is not accumulated in the storage unit 40 at all as in the case of applying power to the device for the first time or the like the evaluation value may be determined using any one of various methods determined in advance such as a method in which a default evaluation value is used.

The keyword history information 42 may be configured to be accumulated when a predetermined operation is input or may be configured to leave only information accumulated for a latest predetermined period among accumulated data and remove the other information. The keyword history information 42 may also be configured to be accumulated up to an upper limit of the data amount and sequentially remove data exceeding the upper limit starting from oldest data.

The selection unit 34 selects content information as a display target for the list screen to be displayed on the operation display unit 20 based on the evaluation value calculated by the interest estimating unit 33 for each distribution information of the predetermined kind acquired by the information acquiring unit 31. The display targets are selected, in accordance with the set display format, so as to extract content information of a predetermined number as the display targets on the list screen.

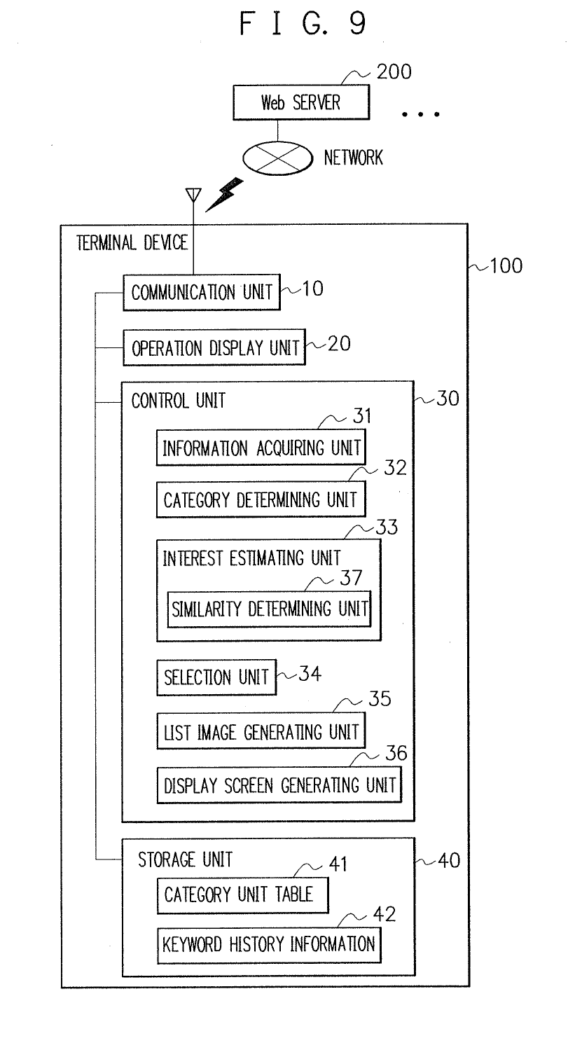

Next, the operation of generating the list display screen that is executed by the terminal device 100 according to the second embodiment will be described with reference to a flowchart represented in FIG. 10.

The similarity determining unit 37 determines a similarity with each keyword history information 42 for each distribution information of the predetermined kind acquired by the information acquiring unit 31 as described above. The interest estimating unit 33 calculates an evaluation value for each distribution information by weighting and adding up the determined similarities according to points associated with the keywords in the keyword history information 42 (Step S11).

The selection unit 34 checks whether the initial list display screen displayed by clicking, on the application selection screen 501, an icon of an application providing the function of this embodiment is set as the list display screen of time order 502 or the list display screen of category order 503.

In a case where the list display screen of time order 502 is set as the initial list display screen, the selection unit 34, for each elapsed time range from the update which is used as the display unit 701 described above, extracts up to a predetermined number of content information in order from content information corresponding to distribution information with the highest evaluation value calculated by the interest estimating unit 33 (Step S12).

For each display unit 701, the number of list images included in the list image group 702 as display targets is set in advance according to the display format as described above. For this reason, the selection unit 34, for each display unit 701, extracts content information to be displayed, corresponding to the distribution information to be displayed, corresponding to the number of the list images as the extraction process of Step S12.

In a case where the list display screen of category order 503 is set as the initial screen, the selection unit 34 adds up the evaluation values of each distribution information calculated by the interest estimating unit 33 for each category unit. Then, the selection unit 34 sets the display order of the category units in order from a category unit with the largest sum of the evaluation values as category units highly interesting to the user (Step S13).

The selection unit 34 extracts content information as display targets up to a predetermined number in order from a highest evaluation value so as to set the content information included in the category units classified into the display categories for a predetermined number of display categories in the top of set display order (Step S14).

The number of list images included in the list image group 702 as display targets is set for each display unit 701 in advance according to the display format as described above. Accordingly, the selection unit 34 extracts the number of content information as a display target for each display unit 701 that corresponds to the number of list images in the extraction process of Step S14.

The number of content information to be extracted for each category unit may be determined appropriately in accordance with the setting or the like. Alternatively, the number of content information to be extracted for each category unit may be calculated using a predetermined method according to a sum of the evaluation values for each category unit.

In this way, when the content information as the display target is extracted by the selection unit 34, the list image generating unit 35 generates list images corresponding to the content information extracted as the display target. Information necessary for generating the list images is set in advance according to the content information. For example, a representative image, an abstract within a predetermined length range, and the like may be set as the information necessary for generating the list images.

For this reason, the list image generating unit 35 checks whether the distribution information of the predetermined kind acquired by the information acquiring unit 31 is sufficient or insufficient for generating list images using for each content information extracted as the display target,. In a case where the information is insufficient, the list image generating unit 35 acquires the missing detailed information, for example, data of a representative image or the like from a web server of the distribution source or the like as the additional information (Step S15).

If the information for each content information as a display target is sufficient for generating list images, the list image generating unit 35 generates list images for each content information by using the information (Step S16).

The display screen generating unit 36 arranges the list images generated by the list image generating unit 35 at predetermined positions on the list display screen of the set display format, thereby generating a list display screen (Step S17). In this way, the list display screen is displayed on the operation display unit 20.

The interest estimating unit 33 monitors predetermined operations such as a reproduction request, a removal request, no operation (an operation for only the other contents), storage, information transmission for another service, and a search for each content of the list image displayed by the display unit (Step S18).

When a predetermined operation input is made for the content information set as the operation target as described above, the interest estimating unit 33 assigns points to content information corresponding to the list image as described above. In addition, the interest estimation unit 33 configures the keyword history information 42 described above by associating assigned points with the extracted keyword group as described above and stores it in the storage unit 40 (Step S19).

In addition, also after a series of the operations of Steps S11 to S19 described above, the interest estimating unit 33 continues to monitor a predetermined operation input relating to the reproduction and recording of various kinds of content information in Step S18. Then, with each predetermined operation input, the interest estimating unit 33 configures the keyword history information 42 by associating the assigned points with the extracted keyword group from the content information set as the operation target as described above and stores the keyword history information 42 in the storage unit 40.

In this way, with each predetermined operation input, the interest estimation unit 33 updates the keyword history information 42 which is used as information to configure the degree of interest accumulated in the storage unit 40, and accordingly, the selection unit 34 selects the different content information next time as the display target. As a result, list images configuring the list display screen changes. For this reason, as the user continues to execute various operations such as a reproduction operation and a recording operation on the list display screen, the user's interest is further reflected on the list images configuring the list display screen.

As above, in the second embodiment described above, the interest estimating unit 33 estimates the degree of interest according to an evaluation value calculated by way of adding up the similarities of stored keyword history information 42 which are weighted according to the points for each distribution information of the predetermined kind acquired by the information acquiring unit 31.

For this reason, in addition to the advantages of the first embodiment described above, the user's degree of interest can be estimated in more detail. Accordingly, the user's interest can be reflected on the list display screen in more detail.

### Third Embodiment

Next, a third embodiment of the present invention will be described. In the third embodiment, the selection unit 34 according to the first embodiment described above is configured to execute a method of selecting a content as described below. Parts corresponding to those of the first embodiment will not be presented here.

In the first or second embodiment described above, with each detection of a user's operation input to content information belonging to a certain category, points corresponding to the operation input are given, and the given points are accumulated for each category. As a result, the user's taste for each category can be acquired. However, in many cases, information that the user desires to know differs for each time period of one day. In other words, the user's taste for categories varies according to a time period.

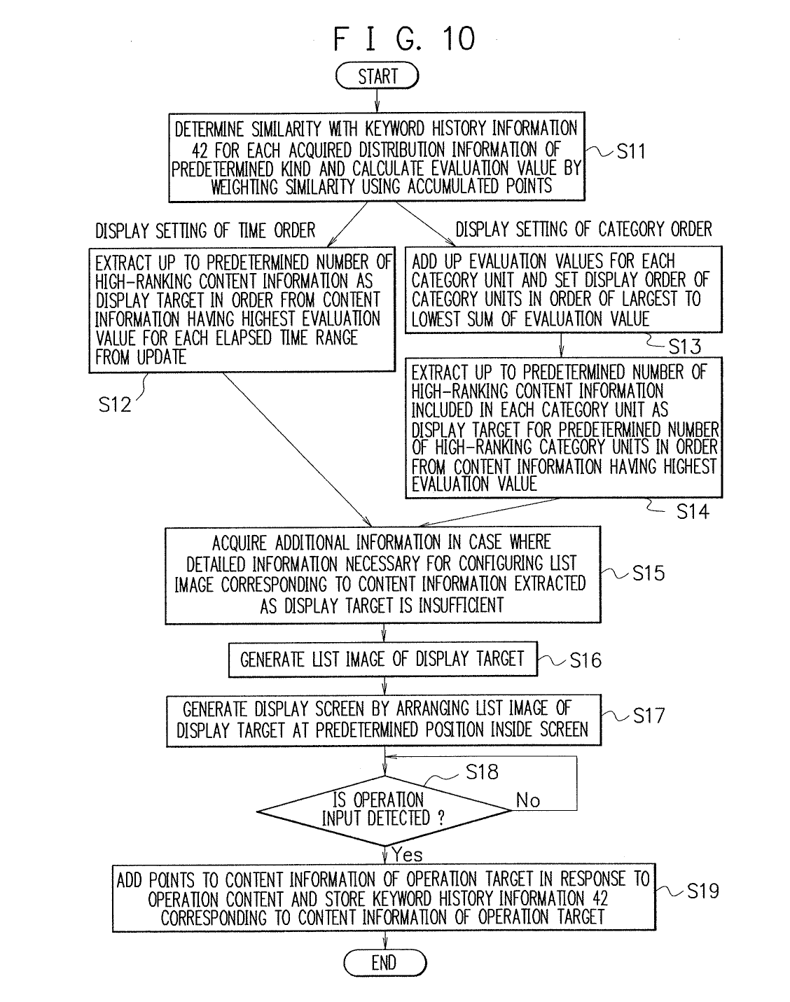

In this embodiment, in order to solve such a problem, the accumulated points are configured to be accumulated not only for each category but for each time period. The time periods may be set by the system in advance or may be arbitrarily set by the user. A specific configuration example is illustrated in FIG. 11. As illustrated in the figure, a storage unit 40 stores a time-period unit table 43 together with a category unit table 41. The time-period unit table 43 stores a setting of time periods such as a first unit of 5:00 a.m. to 11:00 a.m., a second unit of 11:00 a.m. to 6:00 p.m., and a third unit of 6:00 p.m. to 5:00 a.m. of the next day.

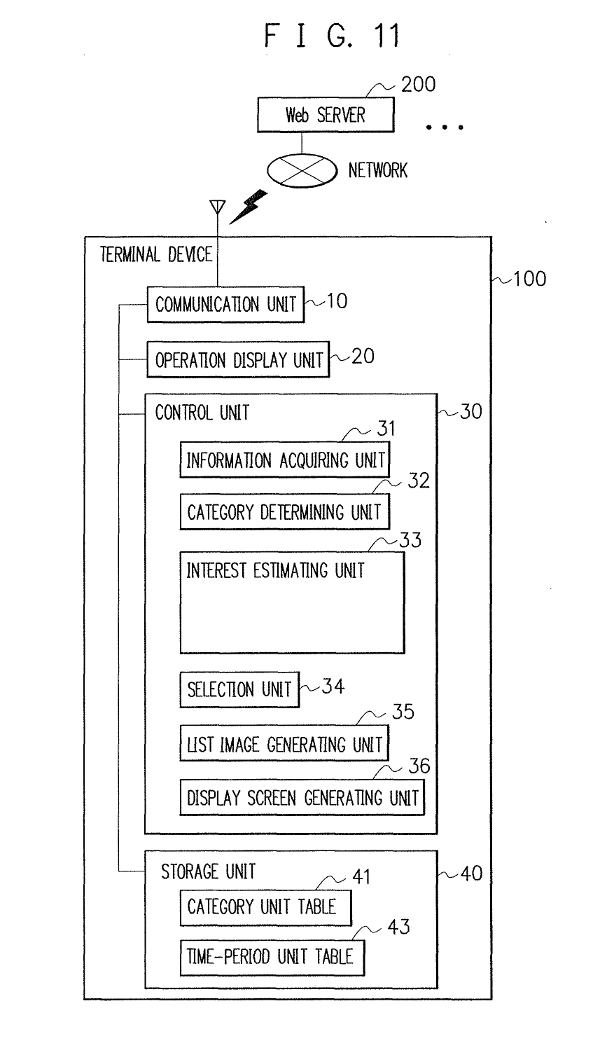

In addition, when the points for each category unit is calculated in S8 represented in FIG. 2, the interest estimating unit 33 adds up the points also for units of time periods. Thus, the points are stored in the storage unit 40 such that a table as illustrated in FIG. 12 can be configured. FIG. 12 is a diagram for describing the concept of accumulated points accumulated for each category and for each time period.

In this way, the selection unit 34 executes the process of S1 to S3 represented in FIG. 2. by using the points P_{CT} accumulated for each category unit and for each predetermined time period. The selection unit 34 determines the display order by referring to the accumulated points corresponding to the time period included in time at which the process is executed for each category or the like and extracts display targets. In other words, points representing the user's taste are accumulated for each time period in addition to each category and are used for the selection process.

The points may be accumulated such that the table as illustrated in FIG. 12 can be configured, and the points P added up in S8 may be configured to be stored in the storage unit 40 in association with the category C and the time T. In such a case, when the selection unit 34 sets the display order in order of accumulated points (S1 represented in FIG. 2), points P associated with time T included in the time period in which the time t at which the process is executed is included may be added up for each category.

In addition, “added up” in S8 represented in FIG. 2 does not mean to limit the calculation method for accumulating points. It is apparent that the calculation method may be integration or any other predetermined calculation method.

Furthermore, this embodiment may be combined together with the second embodiment.

According to this embodiment, in addition to the advantages of the first and second embodiments, the user's taste or interest can be learned in more detail corresponding to a situation in which information desired to be known by the user, a favorite subject, or the like differs according to the time period.

### Fourth Embodiment

Next, a fourth embodiment of the present invention will be described. According to this embodiment, a problem occurring in the third embodiment is solved. As described above, in the third embodiment, points are accumulated at least in units of time periods in addition to units of categories. Accordingly, the points are accumulated such that the table as illustrated in FIG. 12 can be configured. However, as illustrated in FIG. 12, since the points acquired for each category are further divided for each time period, there is a disadvantage that the progress of learning takes time.

Thus, in this embodiment, the learning progress of accumulated points for each time period is compared with the learning progress of accumulated points that are based on only categories regardless of the time periods, and the accumulated points of which the learning progresses further are used, and a filtering process is executed by a selection unit 34. As the accumulated points tend to disperse according to the progress of learning of the user's tastes from the initial state where the accumulated points are the same between categories, the learning progresses of the accumulated points can be compared by comparing the magnitudes of dispersion among the categories.

In this embodiment, a standard deviation is used as a scale that represents the magnitude of dispersion between categories of accumulated points. In order to enable a comparison of magnitudes of dispersion by comparing standard deviations, after each accumulated points are normalized in advance using the following equation, the standard deviations are calculated. Here, T is a constant value set by the system in advance and represents a total sum of accumulated points after normalization.

Pc′=(Pc/(Σ)P)))*T

Here,
Pc: accumulated points of a category c before normalization
Pc′: accumulated points of the category c after normalization
Σ(P): a total sum of accumulated points before normalization.

A process may be an example of the process described above in which, accumulated points depending only on categories regardless of time periods are stored out of the table illustrated in FIG. 12, and the selection process is executed by using accumulated points of a category of which the learning progresses further in comparison with the learning progresses of the accumulated points of the corresponding time period and the learning progress of the accumulated points depending only on categories regardless of time periods .

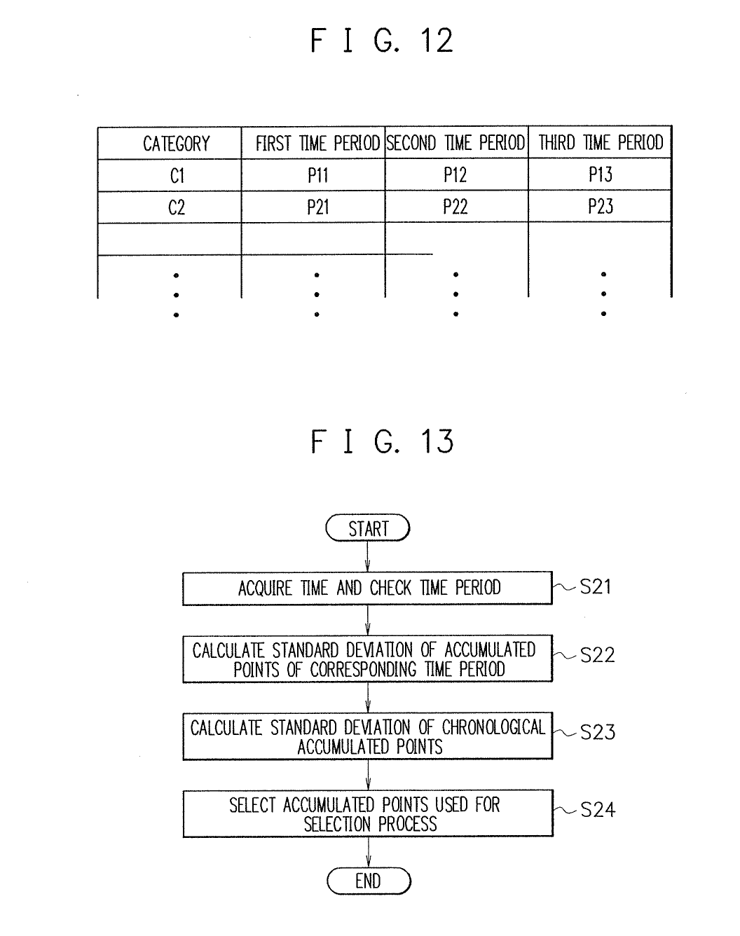

Another example will be described with reference to a flowchart illustrated in FIG. 13. FIG. 13 is an example of the process executed by the selection unit 34 as a subroutine. When the selection unit 34 executes S1 to S3 illustrated in FIG. 2, the selection unit 34 also executes the process illustrated in FIG. 13. First, current time is acquired from a system clock or the like, and the selection unit 34 checks a time period in which the current time is included according to the time-period unit table 43 illustrated in FIG. 11 (S21).

Next, the selection unit 34 calculates a standard deviation of accumulated points acquired by normalizing accumulated points for each category associated with the time period by using the equation described above (S22). In the example illustrated in FIG. 12, for the first time period, a standard deviation of accumulated points acquired by normalizing Pct is calculated. Next, the selection unit 34 calculates a standard deviation of chronologically accumulated points (these accumulated points are also normalized as above by using the equation described above) for each category (S23). Here, for example, in a case where the time period of one day is divided into three time periods as illustrated in FIG. 12, the chronologically accumulated points are points acquired by accumulating all the accumulated points of three time periods for each category. Next, the selection unit 34 compares the standard deviation calculated in S22 with the standard deviation calculated in S23, and the accumulated points of which a larger standard deviation is calculated are used as accumulated points for the selection process (S24).

In this embodiment, content information is selectively filtered according to the user's taste by the selection process using the accumulated points of which the learning progresses further determined by comparing the learning progress of accumulated points for each time period with the learning progress of accumulated points that are depending only on categories regardless of the time period from the viewpoint of dispersion of the accumulated points. As a result, it is possible to solve the problem of low-accuracy filtering in the initial learning stage when the learning progresses in a divisional manner for each time period. This means that the selective filtering can be executed in a certain level of adequacy even in a stage in which the learning of the user's taste of a specific time period does not progress enough.

### Regarding Each Embodiment

Each embodiment described above is a preferred embodiment of the present invention. The present invention is not limited thereto, and the embodiment may be executed with various modifications based on the technical idea of the present invention.

For example, the method of estimating the degree of interest by the interest estimating unit 33 is not limited to the method in which points are given in accordance with the operation content for the content information as described above, or the method as described above in which the evaluation value is calculated, but an arbitrary method may be used as long as the degree of user's interest for the content can be estimated. For example, instead of accumulating points as described above, an average thereof may be calculated.

In addition, the method of weighting the similarity used by the interest estimating unit 33 according to the second embodiment described above is not limited to the method using the points described above. For example, the present invention can be realized by a configuration in which the following elements are used for the calculation of points for the basis of weighting similarly.
Frequency of access to content
Staying time (viewing time) for accessed content
Number of times of access to content
Number of times of clicking a link (in case content information includes the link)
Number of times of searching inside of a text document (in case content information includes a long text)
Number of times of copying (pasting to another application or the like) of a text string included in content information or web searching using the text string
Reproduction order of contents

According to the “reproduction order of contents”, an advantage is acquired that the weighting can reflect the possibility of reproducing contents in order of user's highest to lowest interest.

In addition, the method of selecting contents executed by the selection unit 34 is not limited to the method of simply selecting contents in order based on a result of estimating the degree of interest made by the interest estimating unit 33 as described above. For example, an arbitrary method may be used, such as a method in which the selection is made by executing reinforcement learning by using a total sum as a reward within a predetermined period of point assigned by the interest estimating unit 33.

For example, as the method of selecting contents executed by the selection unit 34, the selection may be configured to further use the degree of importance of a content included in the distribution information of a predetermined kind acquired by the information acquiring unit 31. In such a case, a method may be used in which contents are selected by applying weights to a result of the estimation of the degree of interest, which is acquired by the interest estimating unit 33 described above, in accordance with the degree of importance by using a predetermined algorithm or the like.

In addition, as a method of selecting contents that is executed by the selection unit 34, it may be configured to select contents further using the information of the distribution order among the contents which is determined based on distribution date and time information of the contents included in the distribution information of a predetermined kind acquired by the information acquiring unit 31. In such a case, a method may be used to select contents by, for example, applying weights to a result of the estimation of the degree of interest by the interest estimating unit 33 described above in accordance with the newness of the distribution order by using a predetermined algorithm.

Furthermore, as a variation of a method of selecting contents by the selection unit 34, it may be configured such that operation history information of other users for the content information is further acquired from predetermined address information (a URL or the like). The number of times of reproduction of a movie, the number of recommending persons using a “like” button according to other users, and the like, are the examples of the operation history information of the other users.

In such a case, a method may be used to select contents by applying weights to a result of the estimation of the degree of interest, which is executed by the interest estimating unit 33 described above, in accordance with the operation history information of another user by using a predetermined algorithm.

In this way, the selection unit 34 can select content information based on a various determination factors by configuring the selection unit 34 to select content information by using not only the result of the estimation of the degree of interest, which is executed by the interest estimating unit 33 described above, but also other factors as weights.

In addition, the display format of the list display screen and the specific display screens described above are merely examples, and the present invention is not limited thereto. The display format and the configuration of the display screen may be variously changed in accordance with the settings and the like as long as the list images can be displayed as a list in accordance with the degree of user's interest. For example, the number of items such as the number of list images included in the list image group 702 arranged for each display unit 701 on the list display screen may be arbitrarily set in accordance with the settings and the like.

Furthermore, by including a search function for the distribution information of a predetermined kind, which is acquired by the information acquiring unit 31, in addition to the functions described above, the user may be enabled to search for currently desired information.

In addition, the realized configuration of each function unit of the embodiment described above is arbitrary as long as the function unit can realize the functions described above. Thus, for example, the processing sequence of a program recorded on a recording medium may be realized by either one CPU or a plurality of functional modules.

Furthermore, by recording the processing sequence for realizing the terminal device 100 as the embodiment described above on a recording medium as a program, each of the above-described functions according to the embodiment of the present invention may be realized by causing a CPU of a computer configuring the system to execute the process by using the program supplied from the recording medium.

In such a case, the present invention is applied also to a case where an information group including the program is supplied to an output apparatus by using the recording medium described above or from an external recording medium through a network.

In other words, a program code read from the recording medium realizes the novel functions of the present invention, and the recording medium in which the program code is stored and a signal read from the recording medium configure the present invention.

As such a recording medium, for example, a hard disk, an optical disc, a magneto-optical disk, a floppy (registered trademark) disk, a magnetic tape, a non-volatile memory card, a ROM, or the like may be used.

According to the program relating to the present invention, the functions of the embodiment described above can be realized in a computer that is controlled by the program.

### DESCRIPTION OF REFERENCE NUMERALS

100 Terminal device
200 Web server
10 Communication unit
20 Operation display unit
30 Control unit
31 Information acquiring unit
32 Category determining unit
33 Interest estimating unit
34 Selection unit
35 List image generating unit
36 Display screen generating unit
37 Similarity determining unit
40 Storage unit
41 Category unit table
42 Keyword history information
43 Time-period unit table
601 Icon group
602 Logo mark
700 Display mode setting
701 Display unit
702 List image group

1. A terminal device that is connectable to a server device through a network, the terminal device comprising:
an acquisition means that acquires distribution information of a predetermined kind for content information through the network;
an interest estimating means that estimates a degree of interest of a user using the terminal device for the content information based on an operation content for the content information;
a selection means that selects content information as a display target from new content information corresponding to the distribution information acquired by the acquisition means based on at least the degree of interest for the content information of the past that is estimated by the interest estimating means;
a list information generating means that generates list information used for displaying, as a list, the content information selected by the selection means as the display target by using the distribution information acquired by the acquisition means for each selected content information; and
a display screen generating means that generates a list display screen on which the list information of a predetermined number generated by the list information generating means is arranged,
wherein the interest estimating means update the degree of interest when a predetermined operation input is made for the content information.

2. The terminal device according to claim 1, wherein the interest estimating means estimates the degree of user's interest using the terminal device for the content information by analyzing presence/absence of each operation determined in advance as an operation relating to reproduction and recording of the content information.

3. The terminal device according to claim 1, further comprising a category determining means that determines one of category units set in advance into which the content information corresponding to the distribution information of the predetermined kind acquired by the acquisition means is classified,
wherein the interest estimating means counts points set in advance in accordance with each predetermined operation input relating to reproduction and recording of the content information when the operation input is made, and
wherein the selection means, by using at least the points counted for other content information classified into the category unit into which the content information that is a selection target is classified, selects whether or not the content information is set as the display target.

4. The terminal device according to claim 1, further comprising:
a category determining means that determines one of category units set in advance into which the content information corresponding to the distribution information of the predetermined kind acquired by the acquisition means is classified; and
a storage means,
wherein the interest estimating means includes a similarity determining unit and, in a case where a predetermined operation input relating to reproduction and recording of the content information is made, counts points, which are set in advance in accordance with the predetermined operation input, for the content information for which the operation input is made when the operation input is made and stores the points in the storage means in association with the information corresponding to the distribution information of the predetermined kind acquired for the content information for which the operation input is made,
wherein the similarity determining unit determines a similarity between the information corresponding to the distribution information of the predetermined kind stored in the storage means and the distribution information of the predetermined kind acquired by the acquisition means, and
wherein the interest estimating means estimates the degree of interest for the acquired distribution information of the predetermined kind based on a similarity between the distribution information of the predetermined kind acquired by the acquisition means and the information corresponding to each distribution information stored in the storage means, which is determined by the similarity determining unit, and the points associated with the information corresponding to each stored distribution information.

5. The terminal device according to claim 4,
wherein the interest estimating means calculates an evaluation value for the acquired distribution information of the predetermined kind by weighting similarities determined between the distribution information of the predetermined kind acquired by the acquisition means and the information corresponding to each distribution information stored in the storage means, which is determined by the similarly determining unit, in accordance with the points associated with the information corresponding to the stored distribution information and adding the weighted similarities, and
wherein the selection means selects whether or not the acquired distribution information of the predetermined kind is set as the display target based on at least the evaluation value calculated by the interest estimating means.

6. The terminal device according to claim 3, wherein the selection means selects whether or not the distribution content is set as the display target based on points acquired by accumulating the points counted by the interest estimating means for each category unit and for each predetermined time period by using the accumulated points corresponding to a time period to which time, at which a selection process is executed, belongs.

7. The terminal device according to claim 6, wherein the selection means compares a dispersion of the accumulated points corresponding to the time period to which the time, at which the selection process is executed, belongs among categories with a dispersion of the accumulated points that is regardless of the time period among the categories and executes the selection process by using the accumulated points of which the variation is large.

8. The terminal device according to claim 3, wherein the selection means selects content information set as a display target based on one of the degree of importance of the content information corresponding to the distribution information acquired by the acquisition means, distribution order information among a plurality of content information, and operation history information of other users for the content information or a combination thereof in addition to the degree of interest for the content information of the past that is estimated by the interest estimating means.

9. The terminal device according to claim 3, wherein the list information generating means, in a case where the content information selected as the display target by the selection means is content information of a kind for which other information other than the distribution information of the predetermined kind acquired by the acquisition means needs to be acquired for generating the list information is present, acquires the other information and generates the list information of the content information by using the acquired other information and the distribution information of the predetermined kind acquired by the acquisition means.

10. A program of a terminal device that is connectable to a server device through a network, the program causing the terminal device to execute:
acquiring distribution information of a predetermined kind for content information through the network;
estimating a degree of interest of a user using the terminal device for the content information based on an operation content for the content information;
selecting content information that is a display target from new content information corresponding to the distribution information acquired in the acquiring of the distribution information based on at least the degree of interest for the content information of the past that is estimated in the estimating of the degree of interest;
generating list information used for displaying, as a list, the content information selected in the selecting of the content information as the display target by using the distribution information acquired for each selected content information in the acquiring of the distribution information; and
generating a list display screen on which the list information of a predetermined number generated in the generating of the list information is arranged,
wherein the degree of interest is updated by the estimating of the degree of interest when a predetermined operation input is made for the content information.
